(19) United States
(12) Patent Application Publication
(10) Pub. No.: US 2006/0255669 A1
(43) Pub. Date: Nov. 16, 2006

(54) Flexible diode connection for pressfit bridge rectifier

(75) Inventors: Ronald Gentry, Cicero, IN (US); David A. Fulton, Anderson, IN (US); Keith Yeager, Fishers, IN (US); Christopher L. Congdon, Fishers, IN (US)

Correspondence Address: Thomas A. Walsh;Ice Miller, One Indiana Square, Box 82001, Indianapolis, IN, 46282-0200, US

(73) Assignee: Remy International, Inc., Anderson, IN (US)

(21) Appl. No.: 11/127,453

(22) Filed: May 12, 2005

(51) Int. Cl. H02K 11/04

(52) U.S. Cl. 310/68 D

(57) ABSTRACT

A method of producing a component with a flexible connector attached thereto. The method comprises the steps of forming a loop in a braided conductor, solidifying the loop, and attaching a component lead to said braided conductor. The loop is solidified by joining together the strands of the braided conductor in the looped area, such as by welding or soldering.

### BACKGROUND

The electrical system of a motor vehicle having an internal combustion engine typically comprises an alternator and a battery. The battery provides the direct current necessary to crank the motor vehicle's engine and to power the motor vehicle's electrical components (lights, radio, etc.) when the engine is not running. When the engine is running, the alternator generates electric current to power the motor vehicle's electrical components (lights, radio, etc.) and to recharge the battery.

A typical motor vehicle alternator generates three-phase alternating current that is converted into direct current using a rectifier. FIG. 1 shows a top view of rectifier assembly 10 of a type known in the art. Shown in FIG. 1 are heat sinks 12, insulator 14, and pressfit diodes 16. Insulator 14 comprises three lug terminals 18. Two crimp connectors 20 are electrically connected to each lug terminal 18. Each crimp connector 20 typically is constructed of a copper alloy.

Rectifier assembly 10 is assembled by installing pressfit diodes 16 into heat sinks 12, and installing insulator 14 between heat sinks 12. Each crimp connector 20 is electrically connected to a respective pressfit diode 16 by crimping and/or welding. FIG. 2 shows a side elevation view of a typical connection between a pressfit diode 16 and a crimp connector 20. Shown in FIG. 2 are pressfit diode 16 with diode lead 22 emerging therefrom. The distal end of diode lead 22 is crimped within crimp connector 20. Note that heat sinks 12 and insulator 14 are not shown in FIG. 2 to avoid cluttering the diagram.

Following assembly of rectifier assembly 10, a lead from a motor vehicle alternator (not shown) is connected to each lug terminal 18, thereby electrically connecting two pressfit diodes 16 to the motor vehicle alternator lead.

A primary disadvantage in a typical rectifier assembly arises from the rigid connection between crimp connector 20 and diode lead 22. Operation of a motor vehicle engine causes temperature cycling and vibration of the motor vehicle engine and its components, including the rectifier assembly. Such temperature cycling and vibration induces stress on the rectifier assembly, and on the crimp connectors in particular, resulting in frequent failures of the crimp connectors.

Accordingly, it is desired to provide a more reliable connection for a rectifier assembly diode. A desired connection will provide electrical characteristics similar to the rigid connection of the prior art, but will be less prone to failure in the presence of temperature cycling, vibration, and other environment factors experienced by a motor vehicle rectifier assembly.

### SUMMARY

In an embodiment the present invention comprises a rectifier assembly comprising a heat sink, a diode installed in the heat sink, the diode having at least one lead and a braided conductor having a first end and a second end, the first end being connected to the at least one lead, the second end being formed into an integrated, substantially inflexible terminal.

In an embodiment the present invention comprises a method of producing a component with a flexible connector attached thereto. The method of this embodiment comprises the steps of forming a loop in a braided conductor, solidifying the loop, and attaching a component lead to the braided conductor. In an aspect of this embodiment wherein the braided conductor comprises a plurality of conductive strands, the step of solidifying the loop comprises the step of welding the plurality of conductive strands together in the region of the braided conductor in which the loop is formed. In an aspect of this embodiment wherein the braided conductor comprises a plurality of conductive strands, the step of solidifying the loop comprises the step of soldering the plurality of conductive strands together in the region of the braided conductor in which the loop is formed.

In an embodiment, the present invention comprises a method of producing a plurality of components wherein each component has at least one flexible connector attached thereto. The method of this embodiment comprises the steps of forming a plurality of loops in a braided conductor, solidifying each of the plurality of loops, attaching a plurality of components to the braided conductor wherein the plurality of components being arranged in a predetermined relationship to the plurality of loops, and cutting the braided conductor so that each of the plurality of components has one or more of the plurality of solidified loops attached thereto. In an aspect of this embodiment wherein the braided conductor comprises a plurality of conductive strands, the step of solidifying each of the plurality of loops comprises the step of welding the plurality of conductive strands together in the regions of the braided conductor in which each of the plurality of loops is formed. In an aspect of this embodiment wherein the braided conductor comprises a plurality of conductive strands, the step of solidifying each of the plurality of loops comprises the step of soldering the plurality of conductive strands together in the regions of the braided conductor in which each of the plurality of loops is formed.

In an embodiment, the present invention comprises a method of producing a plurality of components wherein each component has at least one flexible connector attached thereto. The method of this embodiment comprises the step of wrapping a braided conductor around a fixture, and solidifying each of the plurality of loops by welding the plurality of conductive strands together in the regions of the braided conductor in which each of the plurality of loops is formed while the braided conductor is wrapped around the fixture.

In an embodiment, the present invention comprises an improvement to a bridge rectifier assembly of the type to convert alternating current produced by an automotive alternator into direct current. The improvement comprises the use of a braided conductor having a first end and a second end, the first end of the braided conductor being connected to a lead of one of a plurality of pressfit diodes in the bridge rectifier assembly, the second end of the braided conductor being formed into an integrated, substantially inflexible conductive ring, the conductive ring being installed on one of the plurality of terminals of the bridge rectifier assembly to complete an electrical connection between the one of the plurality of pressfit diodes and the one of the plurality of terminals.

### BRIEF DESCRIPTION OF THE DRAWINGS

The features and advantages of this invention, and the methods of obtaining them, will be more apparent and better understood by reference to the following descriptions of embodiments of the invention, taken in conjunction with the accompanying drawings, wherein:

FIG. 1 shows a top view of rectifier assembly of a type known in the art.

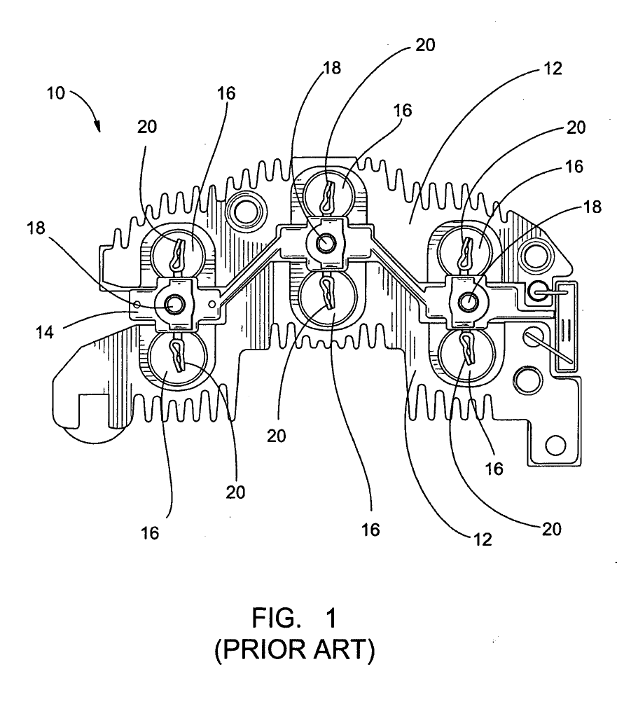

FIG. 2 shows a side elevation view of a typical connection between a pressfit diode and a crimp connector in a rectifier assembly of a type known in the art.

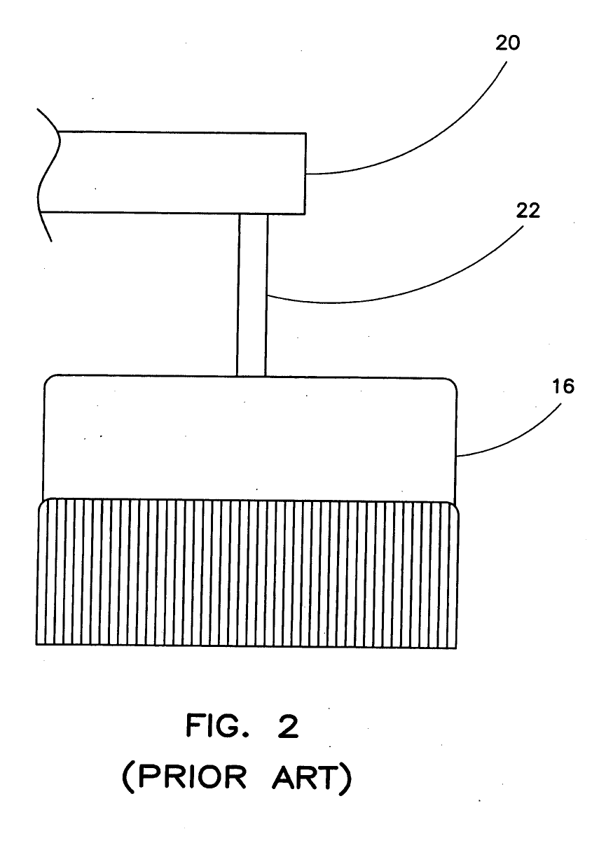

FIG. 3 shows a side elevation view of a diode and flexible connector according to an embodiment of the present invention.

FIG. 4 shows a flowchart illustrating a method for producing a flexible connector according to an embodiment of the present invention.

FIG. 5 shows a top view of an interim point in the production of a plurality of flexible connectors according to an embodiment of the present invention.

FIG. 6 shows a top view of an interim point in the production of a plurality of flexible connectors according to an embodiment of the present invention.

FIG. 7 shows a top view of a flexible connector according to an embodiment of the present invention deployed in a rectifier assembly.

### DESCRIPTION

The present invention comprises a more reliable connection for an electrical or electronic component. A connection according to the present invention is less prone to failure in the presence of temperature cycling, vibration, and other environment factors.

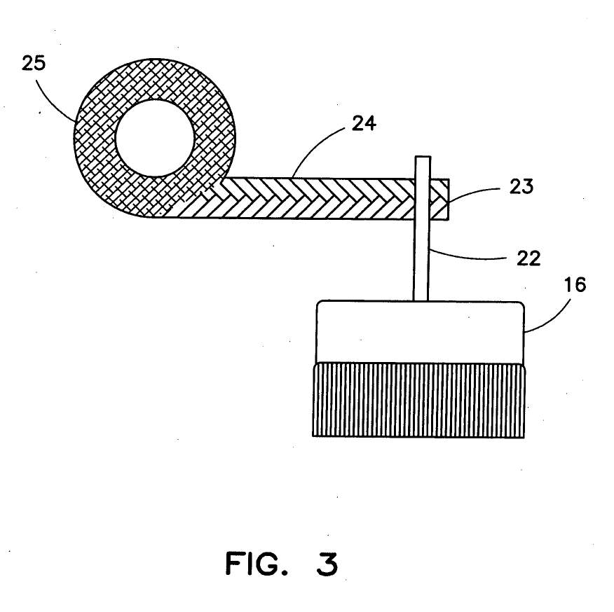

FIG. 3 shows a side elevation view of a diode and flexible connector according to an embodiment of the present invention. Shown in FIG. 3 are pressfit diode 16, diode lead 22, and flexible connector 24. In an embodiment, flexible connector 24 comprises a wire braid conductor having first end 23 and second end 25. First end 23 of flexible connector 24 is connected to lead 22, such as by soldering, welding, or another technique known in the art for creating a mechanical and electrical connection between a wire braid conductor and a component lead. Second end 25 of flexible connector 24 is formed into a ring terminal. As discussed hereinafter, the ring terminal at second end 25 of flexible connector 24 is formed from the wire braid conductor of flexible connector 24, and is integral thereto.

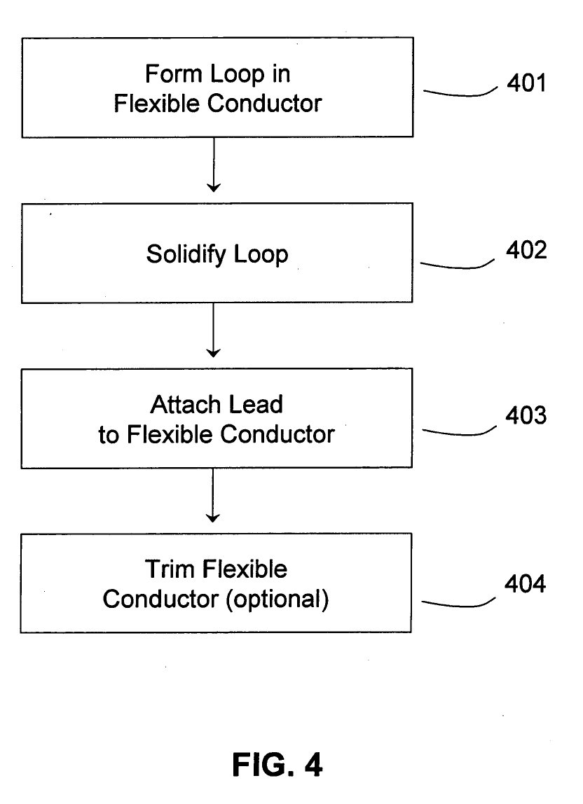

FIG. 4 shows a flowchart illustrating a method for producing a flexible connector according to an embodiment of the present invention. In the step shown as stage 401 of FIG. 4, a loop is formed in a flexible conductor such as a wire braid conductor. The diameter of the loop is sized according to the terminal that is to be received within the center of the loop. A fixture may be used to promote proper sizing of the loop.

In the step shown as stage 402 in FIG. 4, the loop is solidified. In an embodiment of the present invention wherein a wire braid conductor is used, the loop may be solidified by welding the strands of the wire braid conductor together. Other methods of solidifying the looped conductor may be chosen according to, for example, the material from which the loop is formed and/or the application for which the loop is intended. For example, where the loop is formed from a wire braid conductor, the loop may be solidified by soldering. The output of the step shown as stage 402 in FIG. 4 is a flexible conductor with a solidified conductive loop at one end thereof. The portion of the flexible conductor that is outside the outer circumference of the solidified loop remains flexible.

In the step shown as stage 403 of FIG. 4, a lead from an electrical component is attached to the flexible conductor. Attachment of the electrical component lead to the flexible conductor can be accomplished by one of a number of techniques known in the art for creating a mechanical and electrical connection between a flexible conductor and a component lead. In an embodiment where the component lead comprises a pressfit diode lead, attachment of the electrical component lead to the flexible conductor is accomplished by welding or soldering.

Finally, in the step shown as stage 404 of FIG. 4, the flexible conductor may be trimmed if necessary to meet cosmetic or dimensional standards.

The present invention further comprises a method for mass production of flexible connectors. According to the present invention, a plurality of loops are formed in a length of flexible conductor. Two or more of the plurality of loops are solidified simultaneously. In an embodiment, a combined forming and solidifying fixture is used. The flexible conductor is threaded around the fixture to form a plurality of loops, and then two or more of the plurality of loops are solidified simultaneously while within the fixture. In an adaptation of this embodiment, the solidified loops then are expelled from the fixture by mechanical means, and the flexible conductor is advanced by mechanical means so that the next plurality of loops can be formed around the fixture.

After a plurality of loops has been formed in the flexible conductor, a plurality of component leads are attached to the flexible conductor, ordinarily in a ratio of one component lead per solidified loop. The flexible conductor then is cut to create a plurality of flexible connectors with one or more solidified rings at one end, and one or more components at the other end.

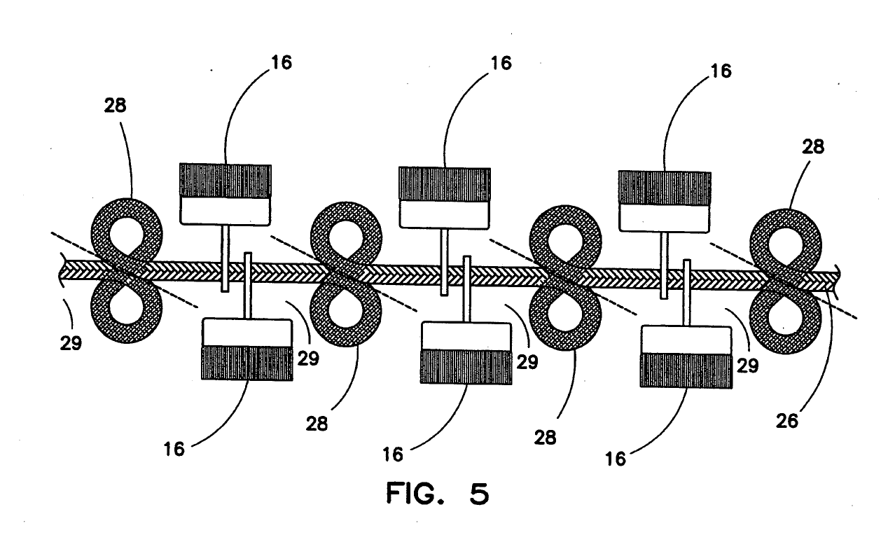

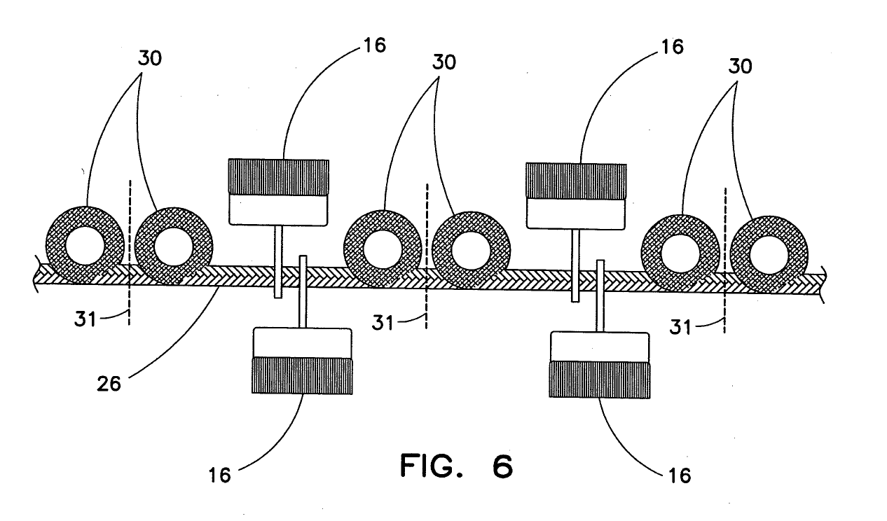

FIGS. 5-6 show top views of a plurality of mass produced flexible connectors according to the present invention. Shown in FIG. 5 is wire braid conductor 26 at an interim point in production. Wire braid conductor 26 has been formed into a plurality of double rings 28, which have been solidified. Two pressfit diodes 16 then have been electrically and mechanically attached to the wire braid conductor 26 between each set of double rings 28. Enough clearance is left between the pair of pressfit diodes 16 to permit wire braid conductor 26 to be cut between the pressfit diodes 16. Preferably, the leads of pressfit diodes 16 are close enough that no trimming of flexible conductor 26 is required after wire braid conductor 26 is cut between the pressfit diodes 16, but far enough apart that damage to the connection between each such lead and wire braid conductor 26 is avoided when wire braid conductor 26 is cut. In addition to cutting wire braid conductor 26 between the leads of pressfit diodes 16, a diagonal cut is made across each set of double rings 28 on the line shown as dashed line 29 in FIG. 5. The result is the assembly shown in FIG. 3 in a mass produced quantity.

FIG. 6 shows a top view of a plurality of mass produced flexible connectors that are produced according to alternate manufacturing processes. Shown in FIG. 6 is wire braid conductor 26 at an interim point in production. Wire braid conductor 26 has been formed into a plurality of double loops 30, which have been solidified. Two pressfit diodes 16 then have been electrically and mechanically attached to the wire braid conductor 26 between each set of double loops 30. Enough clearance is left between the pair of pressfit diodes 16 to permit wire braid conductor 26 to be cut between the pressfit diodes 16. Preferably, the leads of pressfit diodes 16 are close enough that no trimming of flexible conductor 26 is required after wire braid conductor 26 is cut between the pressfit diodes 16, but far enough apart that damage to the connection between each such lead and wire braid conductor 26 is avoided when wire braid conductor 26 is cut. In addition to cutting wire braid conductor 26 between the leads of pressfit diodes 16, a cut is made between each set of double loops 30 on the line shown as dashed line 31 in FIG. 6. The result is the assembly shown in FIG. 3 in a mass produced quantity.

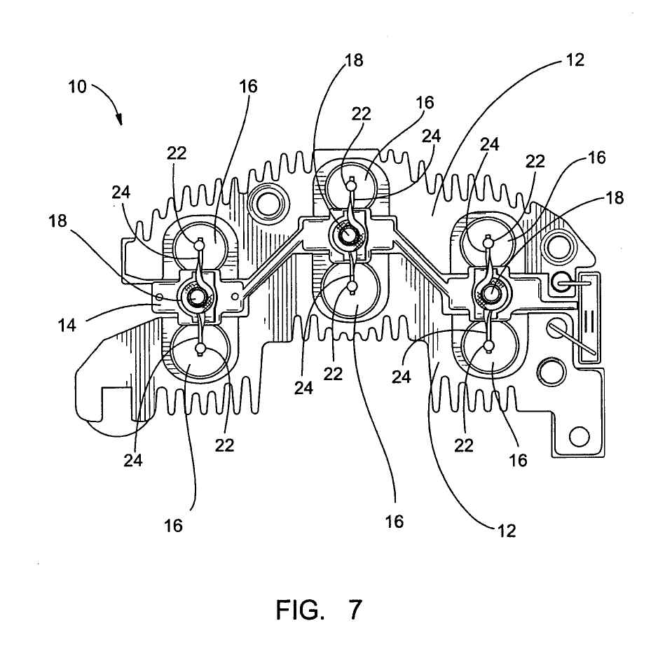

FIG. 7 shows a top view of an embodiment of a flexible connector of the present invention deployed in rectifier assembly 10. Shown in FIG. 7 are heat sinks 12, insulator 14, and pressfit diodes 16. Insulator 14 comprises three lug terminals 18. Pressfit diodes 16 comprise flexible connector 24. Rectifier assembly 10 is assembled by installing pressfit diodes 16 into heat sinks 12, and installing insulator 14 between heat sinks 12. Each flexible connector 24 is electrically connected to a respective lug terminal 18 by inserting the respective lug terminal 18 through the loop in flexible connector 24. A lead from the motor vehicle alternator (not shown) then also is electrically connected to each lug terminal 18, thereby electrically connecting two pressfit diodes 16 to the motor vehicle alternator lead.

While this invention has been described as having a preferred design, the present invention can be further modified within the scope and spirit of this disclosure. This application is therefore intended to cover any variations, uses, or adaptations of the invention using its general principles. For example, the methods disclosed herein and in the appended claims represent one possible sequence of performing the steps thereof. A practitioner of the present invention may determine in a particular implementation of the present invention that multiple steps of one or more of the disclosed methods may be combinable, or that a different sequence of steps may be employed to accomplish the same results. Each such implementation falls within the scope of the present invention as disclosed herein and in the appended claims. Furthermore, this application is intended to cover such departures from the present disclosure as come within known or customary practice in the art to which this invention pertains and which fall within the limits of the appended claims.

We claim:

1. A rectifier assembly comprising:
a heat sink;
a diode installed in said heat sink, said diode having at least one lead; and
a braided conductor having a first end and a second end, said first end being connected to said at least one lead, said second end being formed into an integrated, substantially inflexible terminal.

2. A method of producing a component with a flexible connector attached thereto, the method comprising the steps of:
forming a loop in a braided conductor;
solidifying said loop; and
attaching a component lead to said braided conductor.

3. The method of claim 2, wherein said braided conductor comprises a plurality of conductive strands, and wherein the step of solidifying said loop comprises the step of:
welding said plurality of conductive strands together in the region of said braided conductor in which said loop is formed.

4. The method of claim 2, wherein said braided conductor comprises a plurality of conductive strands, and wherein the step of solidifying said loop comprises the step of:
soldering said plurality of conductive strands together in the region of said braided conductor in which said loop is formed.

5. A method of producing a plurality of components wherein each component has at least one flexible connector attached thereto, the method comprising the steps of:
forming a plurality of loops in a braided conductor;
solidifying each of said plurality of loops;
attaching a plurality of components to said braided conductor, said plurality of components being arranged in a predetermined relationship to said plurality of loops; and
cutting said braided conductor so that each of said plurality of components has one or more of said plurality of solidified loops attached thereto.

6. The method of claim 5, wherein said braided conductor comprises a plurality of conductive strands, and wherein the step of solidifying each of said plurality of loops comprises the step of:
welding said plurality of conductive strands together in the regions of said braided conductor in which each of said plurality of loops is formed.

7. The method of claim 5, wherein said braided conductor comprises a plurality of conductive strands, and wherein the step of solidifying each of said plurality of loops comprises the step of:
soldering said plurality of conductive strands together in the regions of said braided conductor in which each of said plurality of loops is formed.

8. The method of claim 5, wherein the step of forming a plurality of loops in a braided conductor comprises the step of:
forming at least two of said plurality of loops into a FIG. 8 configuration.

9. The method of claim 5, wherein the step of attaching a plurality of components to said braided conductor comprises the step of:
placing leads from said plurality of components in contact with said braided conductor between said plurality of loops; and
welding said leads to said braided conductor.

10. The method of claim 5, wherein the step of attaching a plurality of components to said braided conductor comprises the step of:
placing leads from said plurality of components in contact with said braided conductor between said plurality of loops; and
soldering said leads to said braided conductor.

11. The method of claim 5, wherein said braided conductor comprises a plurality of conductive strands, and wherein:
the step of forming a plurality of loops in a braided conductor comprises the step of wrapping said braided conductor around a fixture, and
the step of solidifying each of said plurality of loops comprises the step of welding said plurality of conductive strands together in the regions of said braided conductor in which each of said plurality of loops is formed while said braided conductor is wrapped around said fixture.

12. The method of claim 5, wherein said braided conductor comprises a plurality of conductive strands, and wherein:
the step of forming a plurality of loops in a braided conductor comprises the step of wrapping said braided conductor around a fixture, and
the step of solidifying each of said plurality of loops comprises the step of soldering said plurality of conductive strands together in the regions of said braided conductor in which each of said plurality of loops is formed while said braided conductor is wrapped around said fixture.

13. In a bridge rectifier assembly of the type to convert alternating current produced by an automotive alternator into direct current, the bridge rectifier assembly comprising a heat sink, a plurality of pressfit diodes installed in the heat sink, and a plurality of terminals electrically connected to the automotive alternator, an improvement comprising:
a braided conductor having a first end and a second end, said first end of said braided conductor being connected to a lead of one of said plurality of pressfit diodes, said second end of said braided conductor being formed into an integrated, substantially inflexible conductive ring, said conductive ring being installed on one of said plurality of terminals to complete an electrical connection between said one of said plurality of pressfit diodes and said one of said plurality of terminals.
